(19) United States
(12) Patent Application Publication
(10) Pub. No.: US 2016/0108289 A1
(43) Pub. Date: Apr. 21, 2016

(54) RELEASE LINER WITH STRUCTURED AND REPOSITIONABLE PROPERTIES

(71) Applicant: AVERY DENNISON CORPORATION, Glendale, CA (US)

(72) Inventor: Robert W. Schneider, Chardon, OH (US)

(21) Appl. No.: 14/888,556

(22) PCT Filed: May 2, 2014
(86) PCT No.: PCT/US2014/036516

§ 371 Date: Nov. 2, 2015

Related U.S. Application Data
(60) Provisional application No. 61/818,645, filed on May 2, 2013.

(51) Int. Cl. C09J 7/02; B32B 37/00; B32B 37/12; B32B 7/12; B32B 7/06

(52) U.S. Cl. CPC C09J 7/0232; C09J 7/0235; C09J 7/0228; C09J 7/0207; C09J 7/0264; B32B 7/12; B32B 7/06; B32B 37/12; B32B 37/0076; C09J 2201/606; C09J 2483/005; C09J 2423/105; C09J 2423/04; B32B 2307/748; B32B 2405/00; B32B 2255/26

(57) ABSTRACT

Adhesive articles and release liners are described. The release liners include nonadhesive components such as nonadhesive particulates along their release face. Upon incorporation in an adhesive article and exposure of an adhesive face thereof, at least a portion of the nonadhesive components are carried along the adhesive face. The release liners also include a deformable layer. The inclusion of the deformable layer in the release liner and the inclusion of the nonadhesive components in the adhesive region imparts repositionable or slidability characteristics to the article.

### CROSS-REFERENCE TO RELATED APPLICATION

The present application claims the benefit of U.S. Provisional Patent Application No. 61/818,645 filed May 2, 2013, which is incorporated herein by reference in its entirety.

### FIELD

The present subject matter relates to adhesive articles, release liners, and related methods of making and using. The adhesive articles and release liners may find usefulness in a variety of applications including, for example, advertising and promotion, screening and tinting, transportation, traffic and safety, labeling, and industrial and graphic displays. In particular, the present subject matter will find a wide application in industrial tapes.

### BACKGROUND

Pressure sensitive adhesives are used in a variety of applications including tapes, labels, and other adhesive articles. Pressure sensitive adhesives have a number of advantages such as strong bonding, and simplicity of application. One drawback of these products is the aggressive initial tack of the pressure sensitive adhesive. A need exists for pressure sensitive adhesives that are repositionable, yet still exhibit a high ultimate adhesion. In view of these somewhat competing characteristics, it is difficult to provide an adhesive article which exhibits a relatively high ultimate adhesion, but which is also repositionable.

### SUMMARY

The difficulties and drawbacks associated with previously known adhesive articles are addressed in the present adhesive articles comprising a unique release liner.

In one aspect, the present subject matter provides an adhesive article comprising an adhesive assembly including a substrate defining a first face and a second face oppositely directed from the first face, and adhesive disposed on one of the first face and the second face thereby defining an adhesive face. The adhesive article also comprises a release liner assembly including a release liner substrate defining a first face and an oppositely directed second face, a deformable layer disposed on one of the first face and the second face of the release liner substrate, and a release coating disposed on the deformable layer thereby defining a release face. The adhesive article additionally comprises an effective amount of nonadhesive components disposed along the release face.

In another aspect, the present subject matter provides a method of imparting repositionable characteristics to an adhesive assembly including a substrate and a layer of adhesive disposed on the substrate, the adhesive layer defining an adhesive face. The method comprises providing a release liner assembly including a release liner substrate defining a first face and an oppositely directed second face, a deformable layer disposed along at least one of the first and second faces of the release liner, and a release coating disposed along the deformable layer thereby defining a release face. The method also comprises disposing an effective amount of nonadhesive component(s) on the release face. The method additionally comprises contacting the release face of the release liner with the adhesive face of the adhesively assembly. Upon separating the release liner from the adhesive assembly to thereby expose the adhesive face, at least a portion of the nonadhesive component(s) is disposed along the adhesive face.

In yet another aspect, the present subject matter provides a method of producing a repositionable adhesive article. The adhesive article includes (i) an adhesive substrate, (ii) an adhesive layer disposed along the adhesive substrate and defining an adhesive face, and (iii) a release liner having a release substrate, a deformable layer disposed along the release substrate, and a release coating on the deformable layer defining a release face. The method comprises providing an effective amount of nonadhesive components along at least one of the adhesive face and the release face. The method also comprises contacting the adhesive face with the release face to thereby produce a repositionable adhesive article.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic cross sectional view of a release liner substrate.

FIG. 2 is a schematic cross sectional view of the liner substrate of FIG. 1 having a plurality of nonadhesive components disposed along a face of the substrate, in accordance with the present subject matter.

FIG. 3 is a schematic cross sectional view of the liner substrate and nonadhesive components of FIG. 2 being joined or laminated with an adhesive assembly, in accordance with the present subject matter.

FIG. 4 is a schematic cross sectional view of a resulting adhesive article after the joining depicted in FIG. 3, and in accordance with the present subject matter.

FIG. 5 is a schematic cross sectional view of another version of an adhesive article in accordance with the present subject matter.

FIG. 6 illustrates separation and removal of the liner substrate from the adhesive article depicted in FIG. 4.

FIG. 7 illustrates separation and removal of the liner substrate from the adhesive article depicted in FIG. 5.

FIG. 8 illustrates a particular embodiment of a liner substrate in accordance with the present subject matter.

FIG. 9 is a graph of Peel Adhesion testing at various dwell conditions for samples evaluated and described herein.

FIG. 10 is a graph of Static Shear testing for samples evaluated and described herein.

FIG. 11 is a graph of Loop Tack testing for samples evaluated and described herein.

FIG. 12 is a graph of Shear Adhesive Failure Test (SAFT) for samples evaluated and described herein.

FIG. 13 is a graph of Peel Adhesion testing at various dwell conditions for samples evaluated and described herein.

FIG. 14 is a graph of Static Shear testing for samples evaluated and described herein.

FIG. 15 is a graph of Loop Tack testing for samples evaluated and described herein.

FIG. 16 is a graph of Peel Adhesion testing at various dwell conditions for samples evaluated and described herein.

FIG. 17 is a graph of Static Shear testing for samples evaluated and described herein.

FIG. 18 is a graph of Loop Tack testing for samples evaluated and described herein.

FIG. 19 is a graph of Shear Adhesive Failure Test (SAFT) for samples evaluated and described herein.

FIG. 20 is a graph of Peel Adhesion testing at various dwell conditions for samples evaluated and described herein.

FIG. 21 is a graph of Static Shear testing for samples evaluated and described herein.

FIG. 22 is a graph of Loop Tack testing for samples evaluated and described herein.

FIG. 23 is a graph of Shear Adhesive Failure Test (SAFT) for samples evaluated and described herein.

### DETAILED DESCRIPTION OF THE EMBODIMENTS

The present subject matter provides various multilayer release liners which are particularly adapted to impart repositionable or slidability characteristics to an adhesive article used therewith. The present subject matter also provides adhesive articles utilizing the noted release liners and related methods of use. The term “repositionable or slidability characteristics” refers to characteristics of the article such that during application, the article may be moved or removed without destroying or disturbing the article or the substrate to which the article is being applied. The present subject matter release liners include effective amounts of nonadhesive components which are carried on or located within the liner. After lamination or application of the liner to an adhesive face such as in forming an adhesive article, and upon removal of the liner to expose the adhesive face, at least a portion of the nonadhesive components are retained by and exposed along the adhesive face. As a result of transferal of at least a portion of the nonadhesive components and/or transferal of a pattern or distribution of the nonadhesive components on the liner to the adhesive face, the unique repositionable or slidability characteristics as described herein are imparted to the adhesive face and/or the adhesive article.

Generally, the adhesive articles comprise one or more layers or regions of adhesive. The adhesive is typically a pressure sensitive adhesive, although the present subject matter includes other types of adhesives. The adhesive articles also comprise a substrate. Single layer and multiple layer substrates or substrate assemblies can be used. The multilayer release liner of the present subject matter comprises a substrate and an optional backing. In certain versions of the present subject matter, the liners also comprise a deformable region and/or a release coating. The liners also comprise nonadhesive components typically in the form of small particulates carried by and at least partially exposed along a release face of the liner which in certain embodiments is provided by a release coating. Each of these aspects is described in greater detail herein.

### Adhesive Article Adhesive

The adhesive layer or region of the adhesive articles may be formed from any suitable adhesive material as desired for a particular purpose or intended use. In one embodiment, the adhesive layer comprises a pressure sensitive adhesive layer. In some applications, the adhesive may be a heat activated adhesive, as distinguished from a pressure sensitive adhesive. The pressure sensitive adhesive can be any pressure sensitive adhesive now known in the art or later discovered. These include rubber based adhesives, acrylic adhesives, vinyl ether adhesives, silicone adhesives, and mixtures of two or more thereof. Included are the pressure sensitive adhesive materials described in “Adhesion and Bonding”, Encyclopedia of Polymer Science and Engineering, Vol. 1, pages 476-546, Interscience Publishers, 2nd Ed. 1985, the disclosure of which is hereby incorporated by reference. The pressure sensitive adhesive materials that are useful may contain as a major constituent an adhesive polymer such as acrylic type polymers, block copolymers, natural, reclaimed or styrene butadiene rubbers, tackified natural or synthetic rubbers, random copolymers of ethylene and vinyl acetate, ethylene-vinyl-acrylic terpolymers, polyisobutylene, poly(vinyl ether), etc. The pressure sensitive adhesive materials are typically characterized by glass transition temperatures in the range of about −70° C. to about 10° C.

Other materials in addition to the foregoing resins may be included in the pressure sensitive adhesive materials. These include solid tackifying resins, liquid tackifiers (often referred to as plasticizers), antioxidants, fillers, pigments, waxes, etc. The adhesive materials may contain a blend of solid tackifying resins and liquid tackifying resins (or liquid plasticizers). Particularly useful adhesives are described in U.S. Pat. Nos. 5,192,612 and 5,346,766, which are incorporated herein by reference.

The adhesive layer may have a thickness as desired for a particular purpose or intended use. In one embodiment, the adhesive layer may have a thickness from about 2 to about 5,000 microns, or from about 2 to about 4,000 microns, or from about 2 to about 3,000 microns, or from about 2 to about 2,000 microns, or from about 2 to about 1,000 microns and particularly from 2 to 150 microns, from 10 to 75 microns, or from 5 to 50 microns. The present subject matter includes adhesive layers having thicknesses less than 2 microns and/or adhesive layers having thicknesses greater than 5,000 microns. In one embodiment, the coat weight of the pressure sensitive adhesive may be in the range of about 1.0 to about 50 grams per square meter (gsm), and in one embodiment about 20 to about 35 gsm. The present subject matter includes the use of coat weights less than 10 gsm and/or greater than 50 gsm.

The construction of the adhesive layer is not limited and may be any suitable construction or configuration as desired for a particular purpose or intended use. For example, in one embodiment, the adhesive layer may be a single layer construction. In another embodiment, the adhesive layer may be a multi-layer construction comprising two or more adhesive layers. In one embodiment, the adhesive layer(s) may also be substantially continuous. In another embodiment, the adhesive layer(s) may be provided as a discontinuous layer or layers.

### Adhesive Article Substrate

The substrate used in the adhesive articles may be any material suitable for such a layer including those that are useful for decorative or graphic image applications. The substrates may have any desired thickness and may have, for example, a thickness from about 10 to about 5,000 microns, or from about 10 to about 4,000 microns, or from about 10 to about 3,000 microns, or from about 10 to about 2,000 microns, or from about 10 to about 1,000 microns and particularly from 10 to 300 microns or 25 to 125 microns. The present subject matter includes substrates having thicknesses less than 10 microns and/or substrates having thicknesses greater than 5,000 microns. Materials suitable for the substrate include, but are not limited to, paper, polyolefins (linear or branched), polyamides, polystyrenes, nylon, polyesters, polyester copolymers, polyurethanes, polysulfones, polyvinylchloride, styrene-maleic anhydride copolymers, styrene-acrylonitrile copolymers, ionomers based on sodium or zinc salts of ethylene methacrylic acid, polymethyl methacrylates, cellulosics, fluoroplastics, acrylic polymers and copolymers, polycarbonates, polyacrylonitriles, and ethylene-vinyl acetate copolymers. Included in this group are acrylates such as ethylene methacrylic acid, ethylene methyl acrylate, ethylene acrylic acid and ethylene ethyl acrylate. Also, included in this group are polymers and copolymers of olefin monomers having, for example, 2 to about 12 carbon atoms, and in one embodiment 2 to about 8 carbon atoms. These include the polymers of alpha-olefins having from 2 to about 4 carbon atoms per molecule. These include polyethylene, polypropylene, poly-1-butene, etc. An example of a copolymer within the above definition is a copolymer of ethylene with 1-butene having from about 1 to about 10 weight percent of the 1-butene comonomer incorporated into the copolymer molecule. The polyethylenes that are useful have various densities including low, medium and high density ranges. The low density range is from about 0.910 to about 0.925 g/cm³; the medium density range is from about 0.925 to about 0.940 g/cm³; and the high density range is from about 0.94 to about 0.965 g/cm³. Films prepared from blends of copolymers or blends of copolymers with homopolymers also are useful. The films may be extruded as a monolayer film or a multi-layered film.

In one embodiment, the substrate is a polymeric substrate, which contains migratory additives. An exemplary substrate is a polyvinylchloride substrate. Such materials typically include additives such as plasticizers and antioxidants. The plasticizer is a high boiling solvent or softening agent, usually liquid. It is an ester made from an anhydride or acid and a suitable alcohol that usually has between 6 to 13 carbon atoms. Suitable plasticizers include adipate, phosphate, benzoate or phthalate esters, polyalkylene oxides, sulfonamides, etc. Examples of plasticizers include, but are not limited to, DOA plasticizer (dioctyl adipate), TEG-EH plasticizer (triethylene glycol di-2-ethylhexanoate), TOTM plasticizer (trioctyl trimellitate), triacetin plasticizer (glyceryl triacetate), TXIB plasticizer (2,2,4-trimethyl-1,3-pentanediol diisobutyrate), DEP plasticizer (diethyl phthalate), DOTP plasticizer (dioctyl terephthalate), DMP plasticizer (dimethyl phthalate), DOP plasticizer (dioctyl phthalate), DBP plasticizer (dibutyl phthalate), polyethylene oxide, toluenesulfonamide, dipropylene glycol benzoate, and the like. The substrate may be configured or shaped as desired for a particular purpose or intended use. The substrate may be a single layer or may comprise multiple layers. Multiple layers may be employed to provide protection, weatherability, printability or other characteristics to the adhesive article. Indicia or graphics, such as information, logos, designs, phrases, pictures, or the like may be applied to the substrate. In one embodiment, indicia may be applied by printing a surface of the substrate.

### Release Liner Substrate

As noted, in certain versions of the present subject matter, the release liner or liner assembly can include one or more deformable layers. The release liner substrate may be monolayered or multilayered. A monolayered release liner may comprise a paper based layer or polymeric based layer. A multilayered release liner may have two or more layers selected from the group including a paper based layer, a polymeric based layer, and combinations of two or more of any of the foregoing layers. The polymeric based layer may include a thermoplastic resin such as a polyolefin, a polyester, or a mixture of the two. The release liner substrate can be formed from any of the materials noted for use as the adhesive article substrate. In certain embodiments of the present subject matter, the liner substrate includes paper or other paper-based materials having a range of weights. A nonlimiting weight for the paper liner substrate is 80/104 g/m².

In particular embodiments, the deformable layer is selected, formed, and/or configured so as to readily deform to the contour and shapes of the nonadhesive component(s) deposited along a release face of the release liner or release assembly. That is, upon deposition or placement of the nonadhesive component(s) on a release face, and optionally after joining with an adhesive assembly; upon application of pressure such as during lamination and/or embossing, the nonadhesive components are at least partially pressed into the deformable layer. This phenomenon can occur in association with either (i) a release liner having a release coating such as a silicone coating on the deformable layer, or (ii) a release liner devoid of a release coating.

### Release Liner Deformable Layer

The deformable layer utilized in the release liner is typically a polyolefin, such as polyethylene or polypropylene. For certain embodiments, the deformable layer includes a majority proportion of polyethylene, more particularly at least 75% polyethylene, more particularly at least 90% polyethylene, and in certain versions at least 95% polypropylene. Any of the polyethylenes described in conjunction with the adhesive article substrate can be used in the deformable layer. In certain versions of the present subject matter, the polyethylene deformable layer is applied at a coat weight of from about 15 to about 40 g/m², more particularly from about 20 to about 30 g/m², and in certain embodiments about 25 g/m². In certain versions of the present subject matter, the deformable layer is provided with one or both faces exhibiting a relatively high gloss.

### Release Liner Release Coating

The release liner typically comprises a release coating on an outer surface of the release liner which is releasably joined to an otherwise exposed surface of the adhesive layer of an adhesive article. The release liner can be coated on one or both sides with the release coating. The release coating can comprise any coating that allows the release liner to be removed from the adhesive layer prior to application of the adhesive article without damaging the adhesive. It is preferable that the release liner is constituted such that it can be subjected to an embossing process without being damaged. The release coating may comprise an organosiloxane polymer. In certain versions of the present subject matter, the release coating includes one or more platinum-cured silicones. In certain embodiments of the present subject matter, the outer face of the release coating is relatively smooth. Also, the liner can be siliconized on both sides in varying amounts or silicones resulting in a differential release system, as used with single linered tapes.

### Release Liner Optional Layers

The release liner may include one or more optional layers such as for example along a face of the liner opposite the release coated or adhesive-facing face. In certain versions of the present subject matter, the one or more optional layers can include a layer of polypropylene. The layer of polypropylene or other polymeric resin may be applied at a coat weight of from 10 to about 30 g/m², more particularly from 15 to 25 g/m², and in certain versions about 20 g/m². In particular embodiments of the present subject matter, the layer of polypropylene or other resin material may be microperforated.

### Nonadhesive Components

In one embodiment, the nonadhesive components or material can be any material that upon drying, cooling, and/or curing is generally not tacky. The nonadhesive material may be made of organic polymeric material such as, for example, polyurethanes, polyvinyl chlorides, acrylic polymers, acetates, polyethylenes, polypropylenes, polystyrenes, or combinations thereof, and the like. In one embodiment, the nonadhesive material is an ink, such as a printing ink. The nonadhesive material may also include oils, pigment dispersions, agglomerations of particles, encapsulated materials or any other material that can be distributed using the methods contemplated in the present subject matter. In one embodiment, the nonadhesive components may all be formed from the same nonadhesive material. In another embodiment, two or more sets or populations of nonadhesive components may be formed from different nonadhesive material compositions. For example, a first set of nonadhesive components may be applied to the release liner in a random or non-regular arrangement using a first nonadhesive material, and a second set of nonadhesive components may be applied to the release liner in a random or non-regular arrangement using a second nonadhesive material. If desired, other sets of nonadhesive components formed from additional nonadhesive materials may be employed. In certain versions of the present subject matter, the nonadhesive component(s) such as ink(s) can be applied in a regular or nonrandom array and/or a repeating pattern.

In one embodiment, the nonadhesive material is a UV-curable ink. Ultraviolet radiation curable inks that are useful as the nonadhesive material may generally comprise a binder that includes one or more photopolymerizable monomers. The photopolymerizable monomers generally are ethylenically unsaturated compounds. The unsaturated compounds may contain one or more olefinic double bonds, and they may be low molecular weight compounds (monomeric), or high molecular weight compounds (oligomeric). Nonlimiting examples of monomers containing one double bond include acrylates such as alkyl(meth)acrylates or hydroxyalkyl(meth)acrylates such as methyl-, ethyl-, butyl-, 2-ethylhexyl- or 2-hydroxyethylacrylate, isobornylacrylate, methyl- or ethylmethacrylate, and the like. Further examples of photopolymerizable monomers include acrylonitrile, acrylamide, methacrylamide, N-substituted (meth) acrylamides, vinyl esters such as vinyl acetate, vinyl ethers such as isobutylvinyl ether, styrene, alkylstyrenes and halostyrenes, N-vinylpyrrolidone, vinyl chloride, vinylidene chloride, and the like.

Suitable monomers containing a plurality of double bonds include, but are not limited to, the diacrylates of ethylene glycol, 1,3-propylene glycol, 1,4-butaneodiol, 1,4-cyclohexane diol, neopentyl glycol, hexamethylene glycol, or bisphenol A polyacrylates such as trimethylolpropane triacrylate and pentaerythritol triacrylate or tetraacrylate, vinyl acrylate, divinyl benzene, divinyl succinate, diallyl phthalate, triallylphosphate, triallylisocyanurate, tris(2-acryloyloxy)ethyl-isocyanurate, and the like.

Examples of suitable high molecular weight (oligomeric) polyunsaturated compounds include, but are not limited to, acrylated epoxy resins, acrylated polyethers, acrylated polyurethanes, acrylated polyesters, and the like. Further examples of suitable unsaturated oligomers include unsaturated polyester resins that are typically prepared from maleic acid, phthalic acid and one or more diols and which have molecular weights of about 500 to about 3000. Such unsaturated oligomers may also be referred to as prepolymers. Single component systems based on photocurable prepolymers are often used as binders for printing inks. Unsaturated polyester resins are typically used in two-component systems together with a monounsaturated monomer such as described above, with styrene for example.

The unsaturated compounds also can be used in admixture with nonphotopolymerisable film-forming components. These components may typically be drying polymers or their solutions in organic solvents, such as nitrocellulose. They may also, however, be chemically curable or thermocurable resins such as polyisocyanates, polyepoxides or melamine resins. The concomitant use of thermocurable resins is contemplated for use in so-called hybrid systems which are photopolymerised in a first step and crosslinked by a thermal after treatment in a second step.

The UV radiation curable inks also may contain at least one photoinitiator. A wide range of different photoinitiators is at present available for UV radiation curable systems. They include benzophenone and benzophenone derivatives, benzoin ethers, benzil ketals, dialkoxyacetophenones, hydroxyacetophenones, aminoacetophenones, haloacetophenones or acryloxyphosphine oxides. They differ in that they have different absorption maxima. To cover a wide absorption range it is possible to use a mixture of two or more photoinitiators. The total amount of photoinitiator in the UV radiation curable compositions may be in the range of, for example, from about 0.05 to about 10% by weight of the total composition. In one embodiment, the compositions contain from about 0.2% to about 5% by weight of the photoinitiator.

Amines may be added to accelerate the photopolymerisation, for example triethanolamine, N-methyl-diethanolamine, p-dimethylaminobenzoate or Michler's ketone. The photopolymerisation can further be accelerated by the addition of photosensitisers that displace or broaden the spectral sensitivity. Suitable photosensitisers include aromatic carbonyl compounds such as thioxanthone, anthraquinone and 3-acyl-coumarin derivatives as well as 3-(aroylmethylene)-thiazolines.

Hindered amine light stabilizers (HALS) that function as co-stabilizers may also be added to UV radiation curable printing compositions used in the present subject matter. Examples of hindered amine light stabilizers include those listed and recited in U.S. Pat. Nos. 5,112,890 and 4,636,408, which are incorporated herein by reference. A specific example of a hinder amine light stabilizer useful in the printing inks is Tinuvin 292, which is identified as bis(1,2,2,6,6-pentamethyl-4-piperidinyl)-sebacate.

In addition to the above described binder materials and photoinitiators, the UV radiation curable inks used in the present subject matter may also contain coloring matter selected from organic pigments, inorganic pigments, body pigments and dyes, which are known and have been used in this art. Examples of useful pigments include, but are not limited to, titanium dioxide, cadmium yellow, cadmium red, cadmium maroon, black iron oxide, carbon black, chrome green, gold, silver, aluminum and copper. Examples of dyes include, but are not limited to, alizarine red, Prussian blue, auramin naphthol, malachite green, etc. Generally the concentration of the pigment or dye in the ink may be from about 0 to about 70% by weight, and in one embodiment, from about 0.1% to about 50% by weight.

In addition to the above described coloring matter, UV radiation curable inks suitable for use as the nonadhesive material may also contain fillers, extenders, surfactants, and the like, which are known and have been used in this art. Examples of useful fillers and extenders include, for example, silicon dioxide, fumed silica, glass or ceramic microspheres, and glass or ceramic bubbles. Generally the concentration of the filler or extender may be from about 0 to about 70% by weight, and in one embodiment, from about 0.5% to about 50% by weight.

Inks suitable for use as the nonadhesive material may also contain at least one UV absorber, which provides weathering protection and helps prevent microcracking. The amount of UV absorber included in, for example, the UV radiation curable ink should be maintained at a practical minimum since the presence of the UV absorber may increase the curing rate. A variety of UV absorbers are known and useful in the nonadhesive material including UV absorbers belonging to the group of photopolymerisable hydroxybenzophenones and photopolymerisable benzotriazoles. U.S. Pat. No. 5,369,140 describes a class of 2-hydroxyphenyl-s-triazines that are useful as UV absorbers for radiation curable systems. The triazines are effective for stabilizing cured films when exposed to sunlight over a long period of time, and these stabilizers do not interfere with UV radiation curing of the inks. The triazine UV absorbers are effective in amounts of from about 0.1 to about 2% by weight. The UV absorbers may be used in combination with other light stabilizers such as sterically hindered amines. The disclosure of the '140 patent is hereby incorporated by reference for its disclosure of such UV absorber combinations. U.S. Pat. Nos. 5,559,163 and 5,162,390 also describe UV absorbers that are useful in the inks of the nonadhesive material.

Examples of useful UV-curable inks include those available from Decochem under the trade designation Poly-Rad plastics, as well as UV-curable inks commercially available from Acheson and Dow Chemical Company.

In one embodiment of the subject matter, the ink used to form the nonadhesive material on the adhesive layer may be a coalescing ink. The ink does not efficiently wet out on the surface of the adhesive, but coalesces into smaller areas of ink with an increase in ink dot height.

In one embodiment of the subject matter, the ink used to form the nonadhesive material comprises a porous nonadhesive. The porous nonadhesive may have elastomeric properties, so that if it is compressed, it essentially returns to its original shape. For example the porous nonadhesive comprises an ink containing a blowing agent that causes the ink to expand, forming an open or closed cell, or combination thereof. The blowing agent is activated, for example, by the application of heat to the ink. Other examples of porous nonadhesives include suspensions of gas and/or particles in a binder. The porous nonadhesive is then embedded into the adhesive layer. The porous nonadhesive fills the depression created in the embedding step, resulting in a facestock layer having a smooth outer appearance.

As described more fully herein, adhesive articles may be formed by applying the nonadhesive material to a carrier web such as a release liner to provide nonadhesive components that are randomly distributed or arranged in a non regular manner on a surface of the carrier web, e.g., on the release surface of a release liner as discrete quantities of nonadhesive material. In one embodiment, while being distributed on the carrier web (e.g., release liner) in a non-regular or random arrangement, the nonadhesive components may be similar or regular in terms of their physical parameters. In another embodiment, the nonadhesive components may be random in one or more physical parameters including size, shape, thickness, height, width, circumference, density, volume of nonadhesive material, and the like. In one embodiment, the nonadhesive components may be in the shape of droplets or microspheres and may, when residing on a surface of a carrier web, such as the release surface of the release liner, have the appearance of hemispheres or mountains.

The dimensions of the nonadhesive components may be controlled to some extent by the method by which they are applied in the carrier web. As used herein, the height of a nonadhesive component is the distance from a base of the component to the peak or apex of the component. For example, a first population of nonadhesive components may have a height h1, and a second population of nonadhesive components may have a height h2. The height of the nonadhesive components is not limited. In one embodiment, the nonadhesive components, when applied to the release liner, may individually have a height of from about 1 to about 50 microns. In one embodiment, the nonadhesive components may individually have a height from about 1 to 25 microns, and in another embodiment the nonadhesive components may individually have a height from about 1 to about 15 microns. However, it will be appreciated that the height of the nonadhesive components may vary depending on the method by which the nonadhesive material is applied. For example, in one embodiment, in which the nonadhesive material is applied by spraying, a first quantity of nonadhesive material may be deposited onto a second quantity of nonadhesive material to provide a relatively large nonadhesive component, which will yield a height greater than the desired height.

The coverage of nonadhesive material may be selected to provide a desired level of slidability or repositionability. The coverage of nonadhesive material may also be selected based on the composition of the adhesive. For example, greater coverage of nonadhesive material may be needed with extremely aggressive adhesives to provide a suitable level of slidability or repositionability. In one embodiment, the nonadhesive components may cover from about 1 to about 75% of the total surface area of the release surface of the release liner. In one embodiment, the nonadhesive components may cover from about 1 to about 50%, in another embodiment from about 1 to about 35%, in another embodiment from about 1 to about 20%, and in another embodiment from about 1 to about 10% of the total surface area of the release surface of the release liner. The nonadhesive material may also cover from about 1 to about 75%, in one embodiment from about 1 to about 50%, in one embodiment from about 1 to about 35%, in one embodiment from about 1 to about 20%, and in one embodiment from about 1 to about 10% of the total surface area of the surface of the adhesive layer.

The nonadhesive material or surface contact elements may provide the adhesive article with repositionability and/or slidability characteristics by reducing the initial tack of the adhesive to the substrate. Without being bound to any particular theory, the nonadhesive material may reduce the initial tack of the adhesive to the substrate by reducing the surface area of the adhesive that is available to initially contact a substrate's surface. The nonadhesive material may reduce the initial tack such that (i) the adhesive article may be initially applied or adhered to a substrate surface and removed therefrom without a substantial loss of adhesive properties and/or without damaging the substrate surface, and/or (ii) the article may be placed against a substrate without pre-adhering to the substrate such that the article may be slid over the substrate's surface into a selected position.

The adhesive articles of the present subject matter can vary in thickness. For example, in certain versions the adhesive articles have an overall thickness (including adhesive layer(s), substrate(s), and release liner(s)) of from about 50 to about 5,000 microns, or from about 50 to about 4,000 microns, or from about 50 to about 3,000 microns, or from about 50 to about 2,000 microns, or from about 50 to about 1,000 microns. In certain versions of the present subject matter, the adhesive articles have an overall thickness of about 2,032 microns (80 mils), and in other versions an overall thickness of about 3,175 microns (125 mils). The present subject matter includes adhesive articles having overall thicknesses less than 50 microns and/or adhesive articles having overall thicknesses greater than 5,000 microns.

### Methods

An adhesive article in accordance with the present subject matter may be formed by applying an adhesive material to an embossed carrier web, such as an embossed release liner, comprising nonadhesive components or particulates, some of which are at least partially embedded in a surface of the carrier web. An embossed carrier web such as a release liner may be provided by (i) applying a nonadhesive material to a surface of a carrier web such that quantities of nonadhesive material are randomly distributed as nonadhesive components on a surface of the carrier web, (ii) at least partially embedding one or more of the nonadhesive components in the carrier web, and (iii) embossing the carrier web to create an embossed pattern. Upon removing the release liner, the adhesive layer has a patterned configuration or topography comprising recessed areas and quantities of nonadhesive material randomly distributed along and/or partially embedded in the surface of the adhesive layer. In one aspect, upon removal of the release liner, the adhesive layer may serve to extract some or all of the nonadhesive components from the release liner. The adhesive article may further contain other layers as desired for a particular purpose or intended use such as, for example, a facestock, a second release liner, or the like.

The nonadhesive material may be applied to a surface of the carrier web, such as a release liner, by any suitable method to randomly distribute quantities of the nonadhesive material on a surface of the release liner to provide a plurality of nonadhesive components. The nonadhesive material may be applied to the release liner by, for example, brushing, spraying, printing, or the like. In one embodiment, the nonadhesive material is applied to the release liner by spraying. Spraying may be accomplished by using a spray gun such as an electrostatic spray gun and/or atomizer. An example of a suitable spray gun includes an AEROBELL DEVILBISS rotary atomizer available from ITW Ransberg Electrostatic Systems. Generally, spray guns include an atomizer housing and a rotating bell or cap spaced from one end of the atomizer housing. The atomizer housing includes rotary turbine engine blades and feed conduits for a solution such as a nonadhesive material. The nonadhesive material is expelled through injection ports at the end of the atomizer housing against the rotating bell or cap, which atomizes the solution and directs a charged or uncharged spray radially outward from the atomizer. The solution is atomized into discrete particles or droplets of various dimensions. Generally, the type of sprayer or spraying system used to apply the nonadhesive material is not limited. Other suitable sprayers include, but are not limited to, high volume, low pressure (HVLP) sprayers.

In one embodiment, the nonadhesive material is applied to a release liner by spraying from a sprayer such as a spray gun. In one embodiment, the spray gun may be attached to a mechanism, such as a robotic arm, and the sprayer may be moved relative to a stationary web of liner material. In another embodiment, the sprayer may be fixed in place and the nonadhesive material may be applied by spraying the material onto a moving web of liner material.

At least one or more of the nonadhesive components may be at least partially embedded into the release liner. Generally, at least a portion of at least one or more of the nonadhesive components are exposed and lie above the plane or face of the release liner. It will be appreciated that some of the nonadhesive components may be “fully” embedded into the release liner such that the upper surface of one or more of the nonadhesive components may be substantially even with or slightly below the plane of the release liner. Embedding the nonadhesive material into the release liner may be carried out by any suitable method using various tools including, for example, pressure rollers or a platen. In one embodiment, embedding may be carried out by using pressure and/or a heated embedding tool. In one embodiment, the release liner may comprise a moldable layer of polymer under a release coating, which softens upon the application of heat and allows the nonadhesive material to be embedded into the liner. The moldable layer may typically be a polyolefin such as, for example, polyethylene. The embedding temperature and/or pressure may be selected based on (i) the materials used for the release liner and/or the nonadhesive material, and/or (ii) the method or tools used to at least partially embed the nonadhesive material. In one embodiment, the embedding temperature may be in the range of about 45° F. to about 300° F. In another embodiment, the embedding temperature may be in the range of about 200° F. to about 250° F. In one embodiment, the embedding pressure may be in the range of about 25 to about 150 pounds per square inch (psi). In one embodiment employing pressure rollers, the embedding nip pressure may be in the range of about 50 to about 140 psi.

The release liner may be embossed to create a pattern of depressions by contacting a surface of the release liner with a patterned embossing tool. In one embodiment, embossing is accomplished by contacting the release surface of the release liner with an embossing tool. The release liner may be embossed by any suitable method including using pressure rollers, a platen, a printing plate, or the like. An embossing tool may be smooth or generally include a topographical pattern, which may be selected to provide a desired adhesive pattern with recesses or channels for air egress. Generally, when the embossing tool contacts the release surface of the release liner, it imparts the inverse of the tool's pattern onto the liner. That is, the patterned topography on the embossing tool is an obverse image of the final topography of the adhesive. The liner serves as the inverse image for transferring the image on the embossing tool to the adhesive. Thus, the embossing tool's topography is essentially the topography of the resulting adhesive layer. While embossing accomplished by pressure is generally preferred, other embossing techniques may be used such as by thermal embossing.

The patterns may be formed of any size, shape, and/or depth, as desired to provide a release liner and eventually an adhesive layer of a desired topography. The pattern may comprise a pattern of geometrical shapes including, but not limited to, circles, ovals, triangles, squares, rectangles, diamonds, trapezoids, pentagons, hexagons, heptagons, octagons, and the like. The pattern may also comprise decorative shapes other than conventional, regular geometric shapes. The pattern may comprise a regular pattern using one repeating shape of the same size and dimensions. Alternatively, the pattern may include an array of a selected shape, e.g., a hexagon, using shapes of different sizes or depths. The pattern may employ two or more different shapes. Even further, the topography may be a random or irregular configuration.

Precision of topographical formation of the release liner can be achieved using a variety of machining techniques, such as those known in the machine tool industry. Suitable tools include planar presses, cylindrical drums, or presses or drums of other curvilinear shapes. More specific examples of suitable tools include photolithographic printing plates and cylinders, precision engraved plates and cylinders, laser machined plates and cylinders, and the like.

During embossing, the embossing tool may be heated or cooled in order to set the embossed shape in the liner web. The temperature may be selected based on the materials used in the release liner. In one embodiment, the embossing tool has a temperature of, for example, about 45° F. to about 300° F. during embossing. In another embodiment, the embossing tool may have a temperature of about 45° F. to about 225° F., and in another embodiment from about 60° F. to about 80° F.

It will be appreciated that other steps may be employed in a process of forming an adhesive article as described herein. For example, if necessary, the method may further comprise drying and/or curing the nonadhesive material prior to embedding and/or embossing. The method may also include heating the nonadhesive material and release liner prior to embedding the nonadhesive material into the release liner and/or embossing the release liner.

In one embodiment, embedding the discrete quantities of nonadhesive material into the release liner and embossing the release liner may be carried out separately and sequentially. In another embodiment, embedding and embossing may be carried out substantially simultaneously.

While the process has been described with respect to embossing the release liner by embossing the release surface of the release liner, it will be appreciated that it may be possible to form an embossed pattern by embossing the outer or back side (i.e., the side opposite the release surface) of the release liner.

It will be further appreciated that embossing may be accomplished after application of an adhesive layer to the release liner. For example, a method of forming an adhesive article may comprise (a) applying discrete quantities of a nonadhesive material to the release surface of the release liner such that the discrete quantities of nonadhesive material are randomly distributed on the release surface, (b) at least partially embedding one or more of the discrete quantities of nonadhesive material into the release liner, (c) applying an adhesive layer onto the release surface of the release layer, and (d) embossing the article.

The adhesive layer can be applied using any suitable method including standard coating techniques, such as curtain coating, gravure coating, reverse gravure coating, offset gravure coating, roller coating, brushing, knife-over roll coating, air knife coating, metering rod coating, reverse roll coating, doctor knife coating, dipping, die coating, pattern bar coating, spraying, and the like. The application of these coating techniques is well known in the industry and can effectively be implemented by one skilled in the art. The knowledge and expertise of the manufacturing facility applying the coating determine the preferred method. Further information on coating methods can be found in “Modern Coating and Drying Technology”, by Edward Cohen and Edgar Cutoff, VCH Publishers, Inc., 1992.

Upon formation of the adhesive layer, the adhesive layer is formed over and about the portions of the nonadhesive material lying above the plane of the release surface of the release liner such that the nonadhesive material is partially embedded in the adhesive layer. When an adhesive layer is applied over the release surface, the adhesive material would fill recessed areas, and the resulting adhesive layer would have a topography that is the inverse of the liner and have a contact surface provided by protruding hexagonal areas separated by channels or recesses. Upon removal of the release liner, the nonadhesive material (such as nonadhesive components) remains embedded in the adhesive layer (such as adhesive layer), with a portion of the nonadhesive material being exposed or extending from the surface of the adhesive layer. Even if some nonadhesive components may be “fully” embedded in the release liner, the bond strength between the adhesive and the nonadhesive material may be sufficient for the nonadhesive components to be bound to the adhesive layer upon removal of the release liner. The recesses or channels (such as recesses) in the patterned adhesive layer provide the adhesive article with air egress characteristics. The exposed, discrete quantities of nonadhesive material facilitate repositionability and/or slidability of the article when it is applied to a substrate.

A facestock or other suitable layer(s) may then be sequentially applied to the adhesive layer as desired to produce a desired adhesive article. The facestock or other layer(s) may be applied using any suitable method including, for example, laminating the layer to the adhesive layer.

An adhesive article may be applied to a substrate as desired. Generally, the release liner may be peeled away from the adhesive layer to expose the embossed adhesive surface comprising discrete quantities of nonadhesive material. As previously described herein, the adhesive surface may have a relatively low initial tack to allow the adhesive article to be (i) placed on the substrate without pre-adhering to the substrate and then slid or moved over the substrate's surface, or (ii) initially adhered to the substrate and subsequently removed from the substrate and repositioned. Once the article is properly aligned or located as desired, the user may apply a force to secure the article to the substrate. The force required to secure the article to the substrate may be greater than that required to secure or adhere a similar adhesive material devoid of any nonadhesive components.

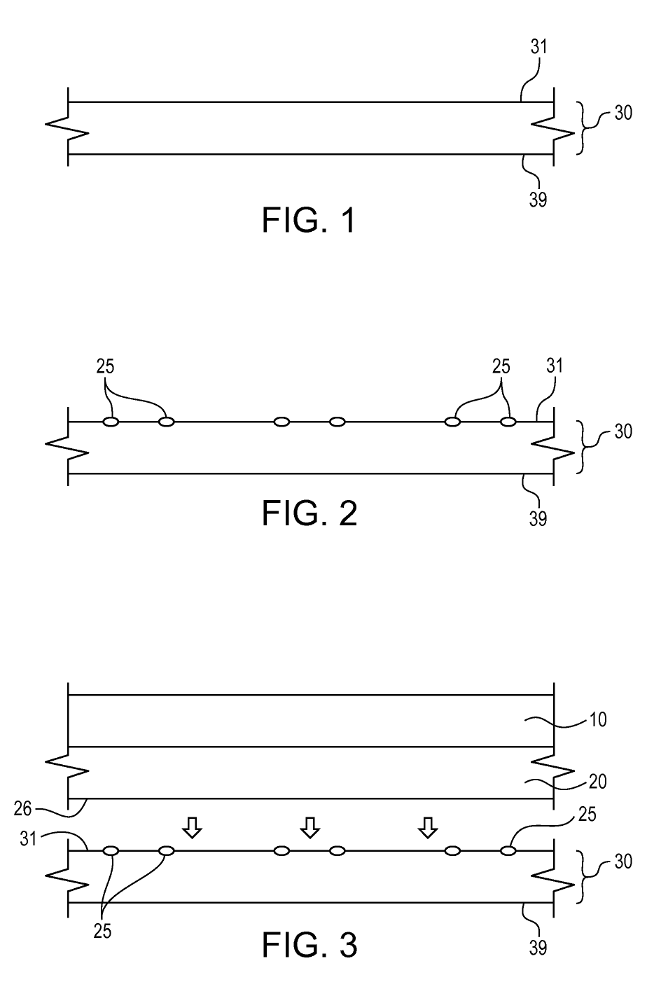

FIG. 1 schematically depicts a cross sectional view of a release liner 30 utilized in the present subject matter. The release liner 30 defines two oppositely directed faces, a first face 31 and a second face 39.

FIG. 2 schematically depicts a cross sectional view of the release liner 30 of FIG. 1. having nonadhesive components 25 disposed along the first face 31. of the liner 30. As schematically depicted in FIG. 2, the nonadhesive components 25 are at least partially embedded in the liner 30 along the first face 31.

FIG. 3 schematically illustrates joining or laminating an adhesive assembly to the liner 30 having nonadhesive components 25 shown in FIG. 2. The adhesive assembly includes an adhesive article substrate 10 and a layer or region of adhesive 20. The adhesive layer 20 defines an adhesive face 26. In the joining or lamination, the face of the release liner 30 along which the nonadhesive components 25 are disposed is contacted with the adhesive face 26 of the adhesive assembly.

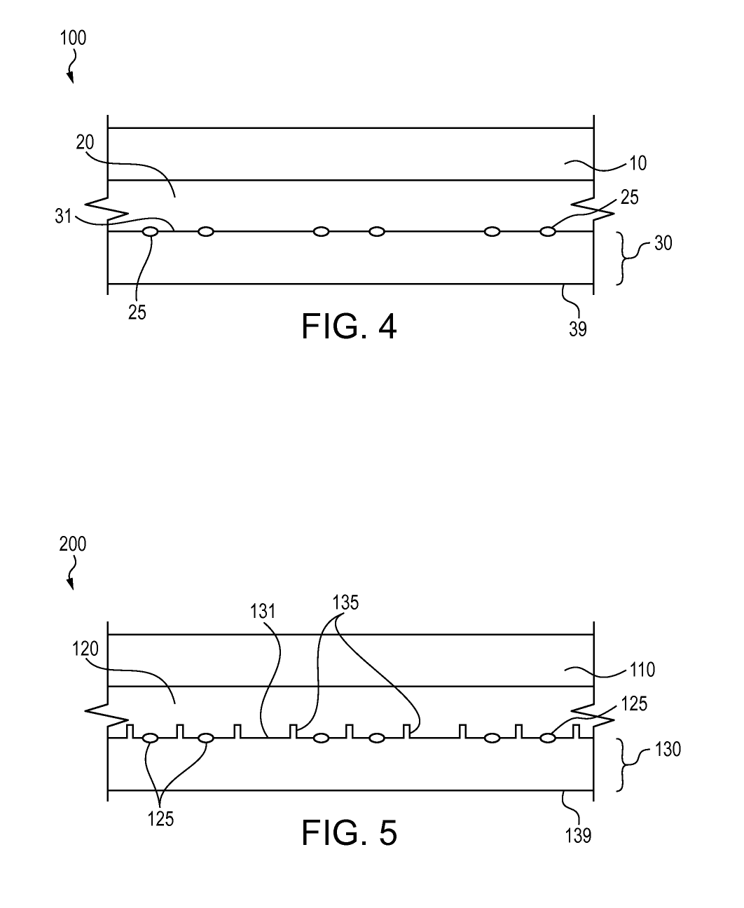

FIG. 4 illustrates an adhesive article 100 resulting from the joining or lamination depicted in FIG. 3. The adhesive article 100 comprises the release liner 30 having nonadhesive components 25 disposed along the face of the liner 30 and generally between the liner 30 and the adhesive layer 20.

FIG. 5 schematically illustrates another adhesive article 200 in accordance with the present subject matter. The article 200 comprises an adhesive article substrate 110, an adhesive layer or region 120, and a release liner 130. The release liner 130 defines two oppositely directed faces, 131 and 139. Disposed along the release face 131 and in contact with the adhesive layer 120 are nonadhesive components 125. The adhesive article 200 includes a provision that the release face 131 directed toward and/or contacting the adhesive layer 120 is embossed or otherwise formed to include a collection of projections 135. The projections 135 can be in nearly any form and are not limited to a rectangular ridge shape schematically depicted in FIG. 5. Upon joining or lamination of the face 131 and projections 135 extending outward therefrom, with the adhesive layer 120, the projections 135 extend into at least a portion of the adhesive layer 120.

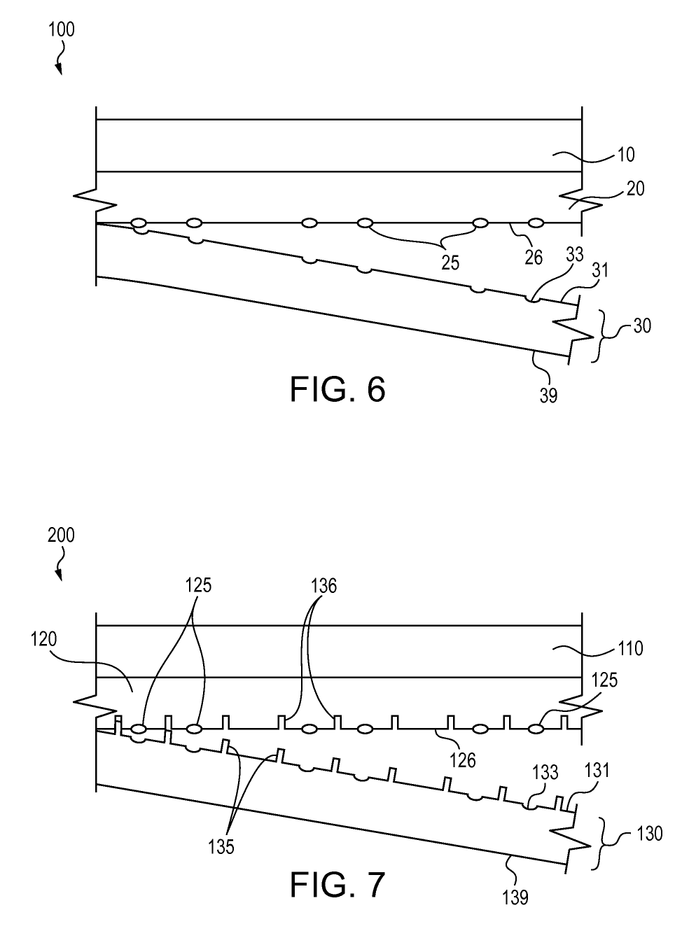

FIG. 6 schematically depicts separation or removal of the release liner 30 from the adhesive assembly of layers 10, 20 depicted in FIG. 4. Upon removal of the liner 30, at least a portion and in the depiction of FIG. 6, all of the nonadhesive components 25 are transferred to and/or remain with the adhesive layer 20. After such transferal or retention of the nonadhesive components 25 to the adhesive face 26, at least a portion of the otherwise exposed adhesive face 26 is covered by the nonadhesive components 25. Furthermore, in the particular version under discussion, the nonadhesive components 25 are at least partially embedded in the adhesive layer 20 along the adhesive face 26. After transferal of nonadhesive components 25 from the liner 30 to the adhesive layer 20, a collection of depressions or recesses 33 are defined and/or remain along the face 31 of the liner 30. As will be appreciated, the depressions 33 signify remnant former locations of nonadhesive components 25 along the liner 30.

FIG. 7 schematically depicts separation or removal of the release liner 130 from the adhesive assembly of layers 110, 120 depicted in FIG. 5. Upon removal of the liner 130, at least a portion and in the depiction of FIG. 7, all of the nonadhesive components 125 are transferred to and/or remain with the adhesive layer 120. After such transferal or retention of the nonadhesive components 125 to the adhesive face 126, at least a portion of the otherwise exposed adhesive face 126 is covered by the nonadhesive components 125. Furthermore, in the particular version under discussion, the nonadhesive components 125 are at least partially embedded in the adhesive layer 120 along the adhesive face 126. After transferal of nonadhesive components 125 from the liner 130 to the adhesive layer 120, a collection of depressions or recesses 133 are defined and/or remain along the face 131 of the liner 130. As will be appreciated, the depressions 133 signify remnant former locations of nonadhesive components 125 along the liner 130. Also, upon removal of the liner 130, the projections 135 remain with the liner 130. Corresponding channels 136 are defined in the adhesive layer 120.

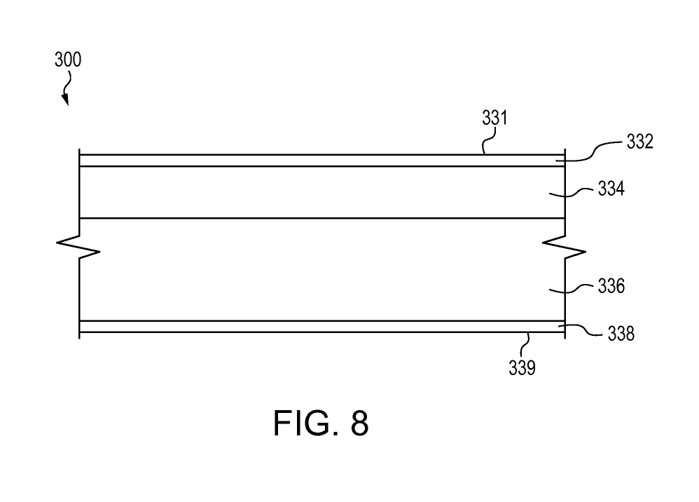

FIG. 8 schematically illustrates a particular version of a multilayer liner 300 in accordance with the present subject matter. The liner 300 comprises a release coating 332 disposed along a deformable layer 334 which is disposed along a substrate 336. The liner 300 defines a release face 331. The liner 300 may optionally comprise a layer 338 of a resin such as polypropylene. The exposed outer face of the liner 300 opposite the release face 331 is shown as face 339. In certain versions of the present subject matter, the layer 338 is microperforated. In the particular version depicted in FIG. 8, the release coating 332 includes a silicone material such as a platinum-cured silicone. The deformable layer 334 includes polyethylene at a coat weight of about 25 g/m². The polyethylene is provided so as to exhibit a glossy face along which the release coating 332 is disposed. In many embodiments, the polyethylene is also the embossable layer. The release substrate 336 can be paper and in certain versions have one or more logos, indicia, or other text or designs printed thereon.

### Examples

A series of evaluations were undertaken to assess the repositionable or slidability characteristics of adhesive articles utilizing the liners and nonadhesive components as described herein. Specifically, samples embodying the present subject matter and designated with an “RS” suffix were compared with corresponding samples. Specifically, the “RS” samples of the present subject matter were compared to equivalent corresponding samples having the same adhesive assembly constructions and materials as the RS samples. However, the RS samples included liner assemblies with deformable layers and effective amounts of nonadhesive components disposed along their release face as described herein. Comparisons were made by subjecting the two sets of samples to one or more of the following tests: (i) 180 Degree Peel Adhesion on Stainless Steel with varying dwell time periods, (ii) Static Shear evaluations, (iii) Loop Tack on stainless steel, and (iv) Shear Adhesion Failure Test (SAFT).

The 180 Degree Peel Adhesion tests were performed in accordance with testing standard PSTC-101 and/or ASTM D903.

Static Shear measures the time required to remove a test sample from a substrate under a specific load. The test applies to the static force to remove an affixed pressure sensitive adhesive from a standard flat surface when the load acts parallel to the surface in a pure shearing action. In Static Shear testing, the samples were cut into 12×51 mm test strips. The test strips were applied to brightly annealed, highly polished stainless steel test panels having a typical size of about 50×75 mm, making a sample overlay of 12×12 mm with the test panel. The sample portion on the test panel was rolled on using a 2 kg, 5.45 pli 65 shore “A” rubber-faced roller, rolling back and forth once, or one time at a rate of 30 cm/min. After a dwell time of at least 15 minutes under standard laboratory testing conditions, the test panels with the test strips were placed at a 2° angle from the vertical, and a load of 500 g was attached to the end of the test strips. The time (in minutes) for the test sample to fail cohesively was measured by a tinier.

Loop Tack measurements were made for strips that were about 25 mm (1 inch) wide using stainless steel as the substrate. Loop Tack measurements were taken using an Instron tester, which was lowered at a rate of about 300 mm/min and taken up at a draw rate of about 50 mm/min. Loop Tack values were taken to be the highest measured adhesion value observed during the test.

The Shear Adhesive Failure Test (SAFT) is a test in which the adhesive is applied to 1′″×0.5″ overlap on stainless steel panels to which a 4.5 lb. roll force is applied. After dwell of 24 hours, the assemblies are placed in an oven and a 500 g load is applied under shear conditions and temperature raised from 40° C. to 200° C. at the rate of 1° C. per minute. The failure temperature is recorded as the shear adhesion failure temperature. This is a measure of the cohesive strength of the adhesive or the ability of the adhesive to maintain a bond at elevated temperatures.

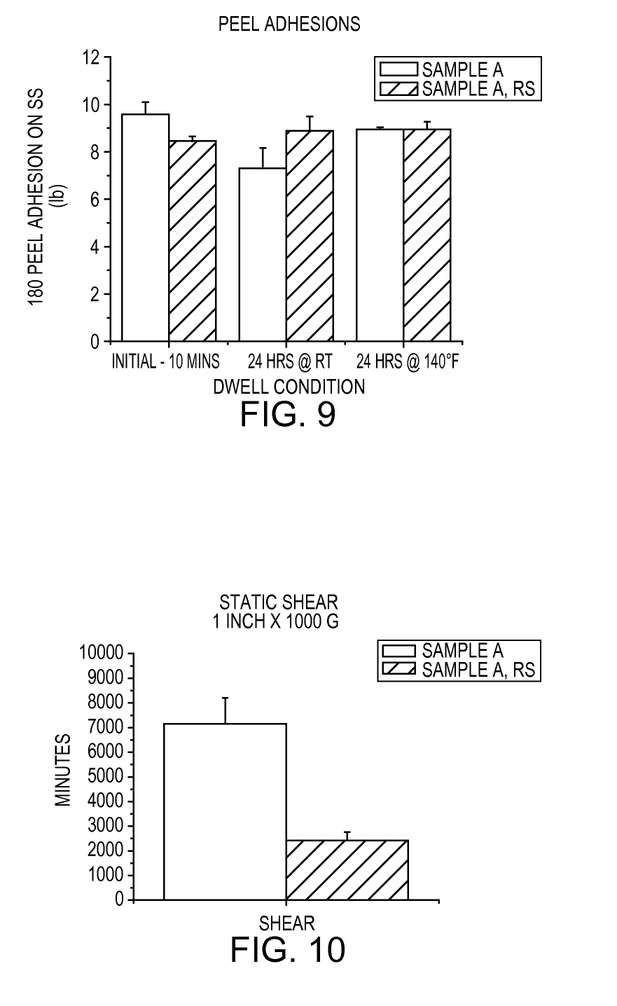

Referring to FIGS. 9-10, samples in accordance with the present subject matter (designated with the suffix “RS”) exhibited reduced or comparable 180 Peel Adhesion values and reduced Static Shear values as compared to corresponding samples.

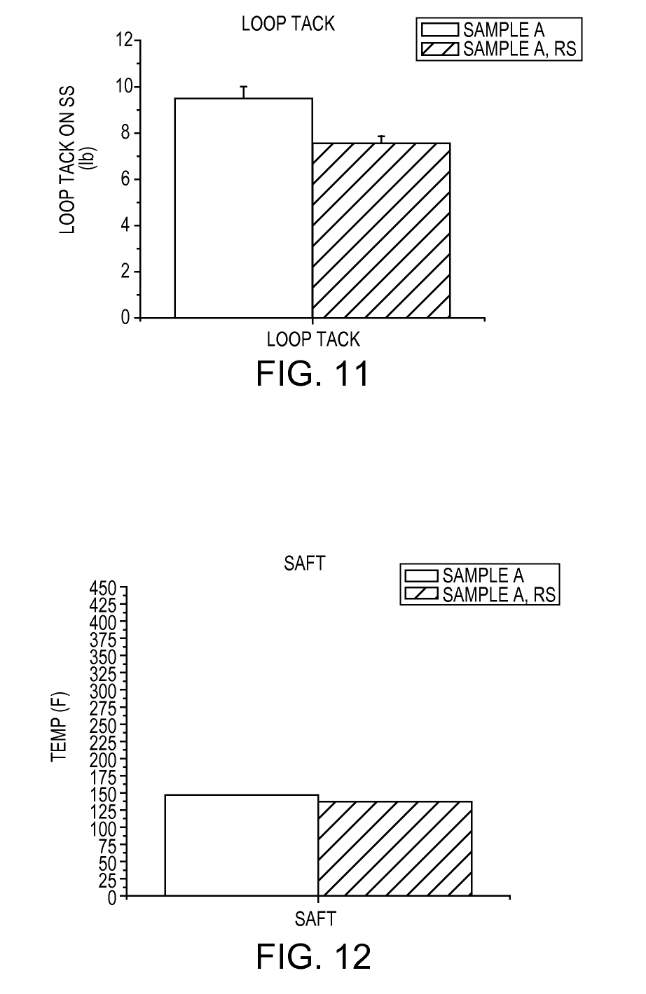

Referring to FIGS. 11-12, samples in accordance with the present subject matter (designated with the suffix “RS”) displayed reduced Loop Tack values yet substantially equivalent adhesive cohesive strength as indicated by the SAFT values; as compared to corresponding samples.

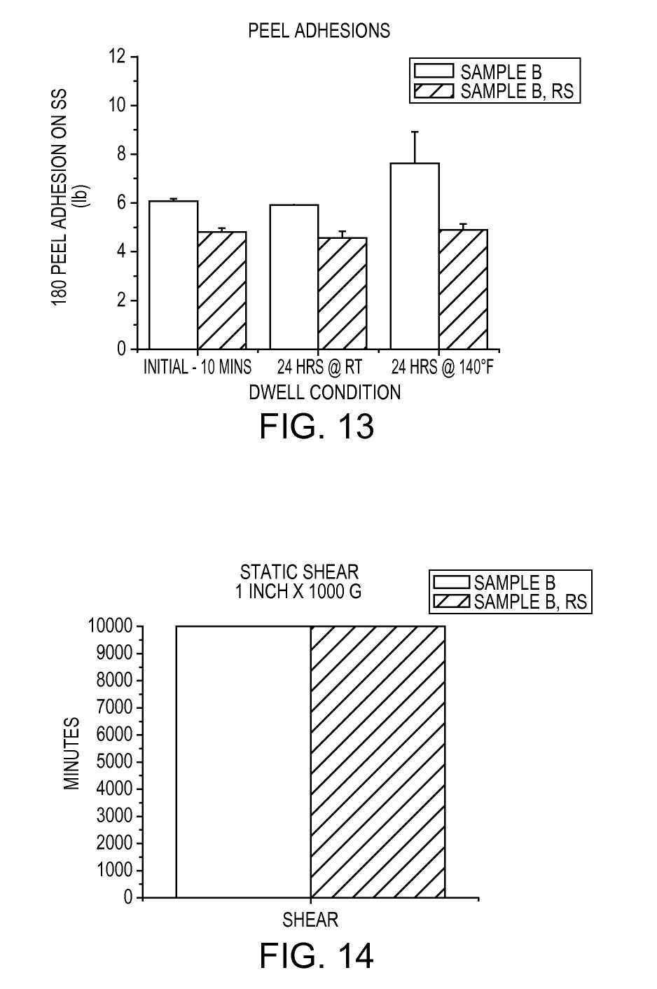

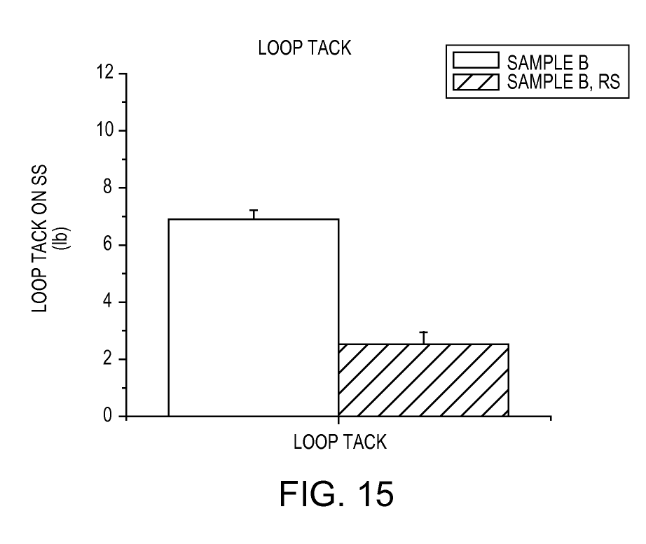

Referring to FIGS. 13-15, samples in accordance with the present subject matter (with the “RS” suffix) exhibited reduced 180 Peel Adhesion values and reduced Loop Tack values, yet equivalent Static Shear values as compared to corresponding samples.

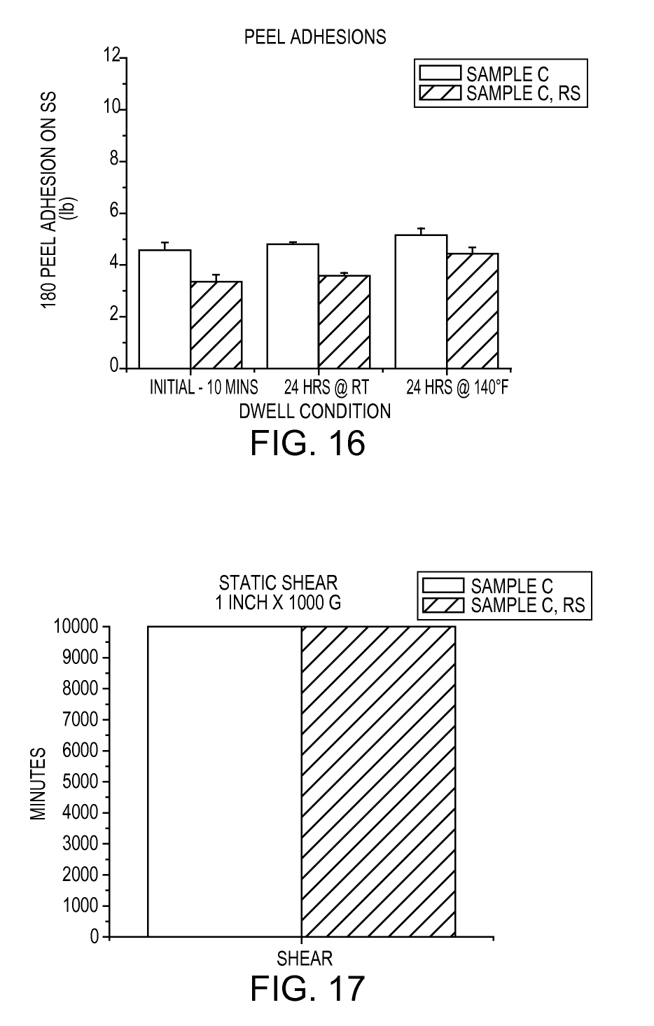

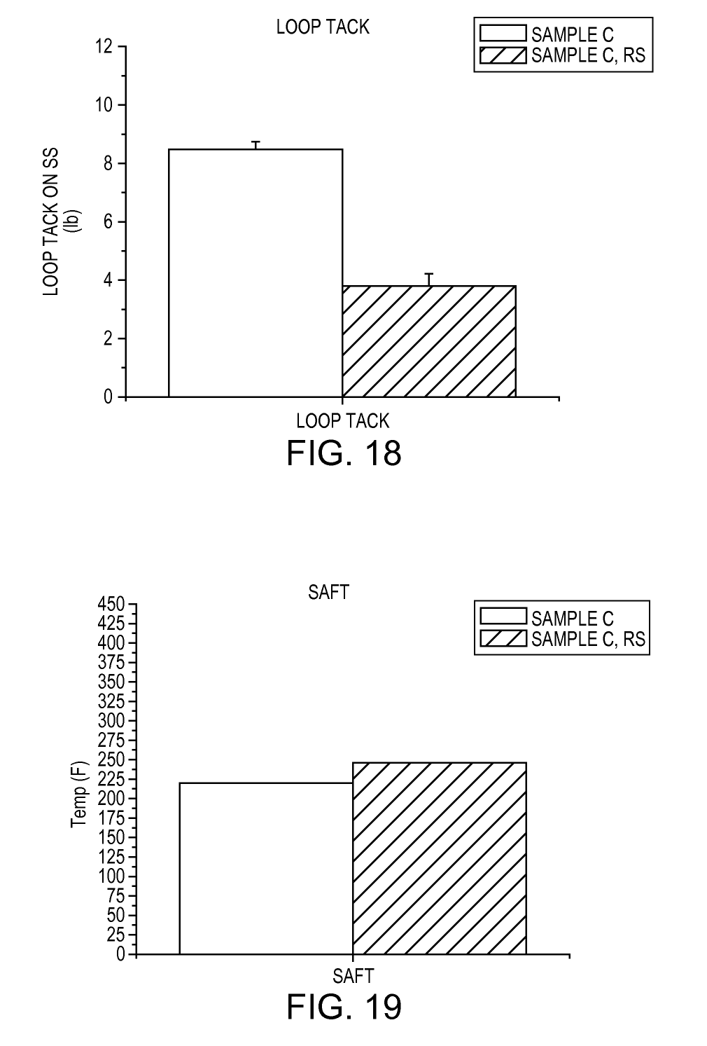

Referring to FIGS. 16-19, samples in accordance with the present subject matter (with the “RS” suffix) exhibited reduced 180 Peel Adhesion values and reduced Loop Tack values, yet also exhibited equivalent Static Shear values and increased SAFT values, as compared to corresponding samples.

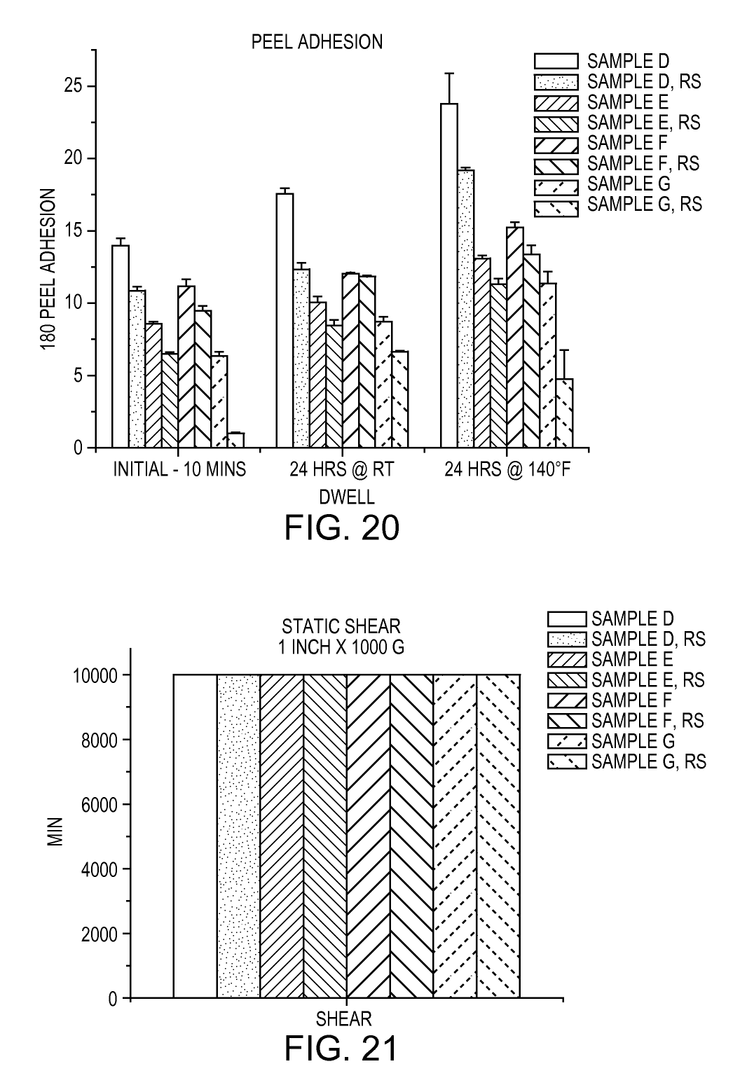

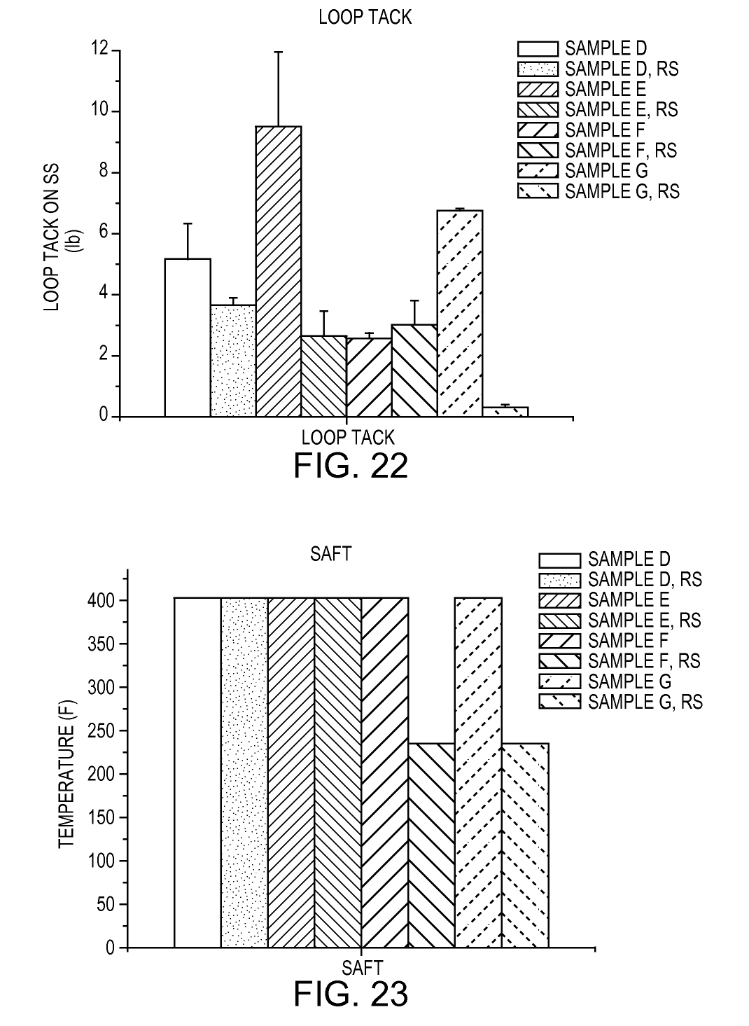

Referring to FIGS. 20-23, samples in accordance with the present subject matter (having the “RS” suffix) exhibited reduced 180 Peel Adhesion values as compared to corresponding samples. All samples exhibited equivalent Static Shear values. Regarding Loop Tack, most of the samples, i.e., sample sets D, E, and G, exhibited a reduced Loop Tack for the samples of the present subject matter. However, samples F of the present subject matter exhibited an increased Loop Tack. Regarding SAFT testing, half of the sample sets, i.e., sample sets D and E, exhibited equivalent SAFT. Sample sets F and G exhibited reduced SAFT for samples in accordance with the present subject matter.

These results generally indicate the repositionable or slidability characteristics of adhesive articles in accordance with the present subject matter. These results also indicate that the repositionable and slidable adhesive articles also relatively high ultimate adhesion and in many or most instances, adhesive strength that is equivalent to corresponding adhesive articles which lack the repositionable and slidability characteristics.

Many other benefits will no doubt become apparent from future application and development of this technology.

All patents, applications, standards, and articles noted herein are hereby incorporated by reference in their entirety.

As described hereinabove, the present subject matter solves many problems associated with previous strategies, systems and/or articles. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

1. An adhesive article comprising:
an adhesive assembly including a substrate defining a first face and a second face oppositely directed from the first face, and adhesive disposed on at least one of the first face and the second face thereby defining an adhesive face;
a release liner assembly including a release liner substrate defining a first face and an oppositely directed second face, a deformable layer disposed on one of the first face and the second face of the release liner substrate, and a release coating disposed on the deformable layer thereby defining a release face; and
an effective amount of nonadhesive components disposed along the release face.

2. The adhesive article of claim 1 wherein the adhesive face of the adhesive assembly is in contact with the release face of the release liner assembly, and at least a portion of the nonadhesive components is disposed between the adhesive face and the release face.

3. The adhesive article of claim 1 wherein the release liner assembly includes a polymeric layer along one of the faces of the release liner substrate opposite the face upon which the deformable layer is disposed.

4. The adhesive article of claim 3 wherein the polymeric layer includes polypropylene.

5. The adhesive article of claim 3 wherein the polymeric layer defines a plurality of microperforations.

6. The adhesive article of claim 3 wherein the polymeric layer is disposed on the release liner substrate at a coat weight of from 10 g/m² to 30 g/m².

7. The adhesive article of claim 1 wherein the release liner substrate includes paper.

8. The adhesive article of claim 1 wherein the deformable layer includes polyethylene.

9. The adhesive article of claim 1 wherein the deformable layer includes one or more polymeric resins and is disposed on the release liner substrate at a coat weight of from 15 g/m² to 40 g/m².

10. The adhesive article of claim 1 wherein the release coating includes at least one silicone agent.

11. The adhesive article of claim 1 wherein the adhesive is a pressure sensitive adhesive.

12. The adhesive article of claim 1 wherein the adhesive assembly substrate includes at least one polymeric material.

13. The adhesive article of claim 1 wherein the nonadhesive components include at least one material selected from the group consisting of polyurethanes, polyvinyl chlorides, polyacrylates, acetates, polyethylenes, polypropylenes, polystyrenes, and combinations thereof.

14. The adhesive article of claim 1 wherein the nonadhesive component includes an ink composition.

15. The adhesive article of claim 1 wherein the overall thickness of the adhesive article is within a range of from 50 to 5,000 microns.

16. The adhesive article of claim 15 wherein the overall thickness of the adhesive article is about 2,032 microns.

17. The adhesive article of claim 15 wherein the overall thickness of the adhesive article is about 3,175 microns.

18. A method of imparting repositionable characteristics to an adhesive assembly including a substrate and a layer of adhesive disposed on the substrate, the adhesive layer defining an adhesive face, the method comprising:
providing a release liner assembly including a release liner substrate defining a first face and an oppositely directed second face, a deformable layer disposed along at least one of the first and second faces of the release liner, and a release coating disposed along the deformable layer thereby defining a release face;
disposing an effective amount of nonadhesive component(s) on the release face;
contacting the release face of the release liner with the adhesive face of the adhesively assembly; and
whereby upon separating the release liner from the adhesive assembly to thereby expose the adhesive face, at least a portion of the nonadhesive component(s) is disposed along the adhesive face.

19. The method of claim 18 wherein the release liner assembly includes a polymeric layer long one of the faces of the release liner substrate opposite the face upon which the deformable layer is disposed.

20. The method of claim 19 wherein the polymeric layer includes polypropylene.

21. The method of claim 19 wherein the polymeric layer defines a plurality of microperforations.

22. The method of claim 19 wherein the polymeric layer is disposed on the release liner substrate at a coat weight of from 10 g/m² to 30 g/m².

23. The method of claim 18 wherein the release liner substrate includes paper.

24. The method of claim 18 wherein the deformable layer includes polyethylene.

25. The method of claim 18 wherein the deformable layer includes one or more polymeric resins and is disposed on the release liner substrate at a coat weight of from 15 g/m² to 40 g/m².

26. The method of claim 18 wherein the release coating includes at least one silicone agent.

27. The method of claim 18 wherein the adhesive is a pressure sensitive adhesive.

28. The method of claim 18 wherein the adhesive assembly substrate includes at least one polymeric material.

29. The method of claim 18 wherein the nonadhesive components include at least one material selected from the group consisting of polyurethanes, polyvinyl chlorides, polyacrylates, acetates, polyethylenes, polypropylenes, polystyrenes, and combinations thereof.

30. The method of claim 18 wherein the nonadhesive component includes an ink composition.

31. The method of claim 18, wherein the release line is embossed.

32. The method of claim 18, further comprising the step of embossing the carrier web to create and embossed pattern.

33. The method of claim 31, wherein the adhesive layer after removing the release liner has a patterned configuration or topography comprising recessed areas.

34. The method of claim 33, wherein quantities of nonadhesive material randomly distributed along and/or partially embedded in the surface of the adhesive layer after removing the release liner.

35. A method of producing a repositionable adhesive article, the adhesive article including (i) an adhesive substrate, (ii) an adhesive layer disposed along the adhesive substrate and defining an adhesive face, and (iii) a release liner having a release substrate, a deformable layer disposed along the release substrate, and a release coating on the deformable layer defining a release face, the method comprising:
providing an effective amount of nonadhesive components along at least one of the adhesive face and the release face; and
contacting the adhesive face with the release face to thereby produce a repositionable adhesive article.

36. The method of claim 35 wherein the release liner includes a polymeric layer along one of the faces of the release substrate opposite the face upon which the deformable layer is disposed.

37. The method of claim 35 wherein the polymeric layer includes polypropylene.

38. The method of claim 36 wherein the polymeric layer defines a plurality of microperforations.

39. The method of claim 36 wherein the polymeric layer is disposed on the release liner substrate at a coat weight of from 10 g/m² to 30 g/m².

40. The method of claim 34 wherein the release liner substrate includes paper.

41. The method of claim 35 wherein the deformable layer includes polyethylene.

42. The method of claim 35 wherein the deformable layer includes one or more polymeric resins and is disposed on the release liner substrate at a coat weight of from 15 g/m² to 40 g/m².

43. The method of claim 35 wherein the release coating includes at least one silicone agent.

44. The method of claim 35 wherein the adhesive is a pressure sensitive adhesive.

45. The method of claim 35 wherein the adhesive assembly substrate includes at least one polymeric material.

46. The method of claim 35 wherein the nonadhesive components include at least one material selected from the group consisting of polyurethanes, polyvinyl chlorides, polyacrylates, acetates, polyethylenes, polypropylenes, polystyrenes, and combinations thereof.

47. The method of claim 30 wherein the nonadhesive component includes an ink composition.

48. The method of claim 35, wherein the release liner is embossed.

49. The method of claim 35 further comprising the step of embossing the carrier web to create an embossed pattern.

50. The adhesive article of claim 1, wherein the release liner is embossed.
